(19) United States
(12) Patent Application Publication
(10) Pub. No.: US 2009/0313118 A1
(43) Pub. Date: Dec. 17, 2009

(54) ACCESS ROUTER, DHCP SERVER, ROUTER ADVERTISEMENT TRANSMITTING SYSTEM, METHOD FOR ROUTER ADVERTISEMENT TRANSMITTING SYSTEM, ANCHOR ROUTER AND PROGRAM

(76) Inventor: Ippei Akiyoshi, Tokyo (JP)

Correspondence Address: Mr. Jackson Chen, 6535 N. STATE HWY 161, IRVING, TX, 75039, US

(21) Appl. No.: 12/441,818

(22) PCT Filed: Jun. 19, 2007
(86) PCT No.: PCT/JP2007/062349

§ 371 Date: Mar. 18, 2009

(30) Foreign Application Priority Data
Sep. 19, 2006 (JP) 2006-252795

(51) Int. Cl. G06Q 30/00; G06F 15/177; G06F 15/173

(52) U.S. Cl. 705/14.49; 705/14.73; 709/221; 709/238

(57) ABSTRACT

When terminals needing different IP configuration information are mixed under the same link, it is necessary to individually transmit a router advertisement to each of the terminals. By including means for transmitting the router advertisement to a solicited-node multicast address, and means for assigning an IP address corresponding to the solicited-node multicast address, a group of the terminals needing the same IP configuration information are grouped so as to include the same solicited-node multicast address, thereby, the router advertisement for each group can be applied.

### TECHNICAL FIELD

The present invention relates to an efficient router advertisement transmitting technique, and particularly, to a router advertisement transmitting technique in which a router advertisement can be transmitted by grouping a variety of terminals, which are mixed under the same access router, for each feature.

### BACKGROUND ART

An example of a related router advertisement transmitting system is described in the Non-Patent Document 1. FIG. 1 illustrates a configuration diagram of the router advertisement transmitting system when the mobility is provided to a mobile terminal by using Network-based Localized Mobility Management (NetLMM).

This related router advertisement transmitting system is configured with a network 1 including Local Mobility Anchor (LMA) 121, 122, 123, Mobility Access Gateway (MAG) 131, 132, 133, and a DHCP server 150, operators 11, 12, and 13, and mobile terminals 41-1, 41-2, 42, and 43.

The operators 11, 12, and 13 are service providers providing an IP service such as HTTP to the contracted mobile terminal, and include different subnets.

The LMA is an anchor router for the mobile terminal moving in the Network 1, and when receiving an IP packet for the mobile terminal, whose movement is managed, the LMA capsules the IP packet to transfer the capsuled IP packet to the MAG in which the mobile terminal exists. The LMAs 121, 122, and 123 correspond to the operators 11, 12, and 13, respectively.

The MAG is a router which registers a location to the LMA instead of the mobile terminal when the mobile terminal moves under the own control. The MAG also includes a function as DHCP Relay Agent. Further, the MAGs 131, 132, and 133 are independent from the operators 11, 12, and 13.

The DHCP server 150 includes a function for assigning an IP address corresponding to the subnet included by the operator contracting each mobile terminal.

The mobile terminal is a terminal which can move in the network 1 as communicating. The mobile terminals 41-1 and 41-2 contract with the operator 11, the mobile terminal 42 contracts with the operator 12, and the mobile terminal 43 contracts with the operator 13.

The related router advertisement transmitting system with such a configuration operates as follows. FIG. 2 illustrates a sequence diagram in which the mobile terminal 41-1 executes communication from an initial access to the network 1 to a communication start in the related router advertisement transmitting system. When entering the network 1, the mobile terminal 41-1 establishes a link with the MAG 131. After that, the mobile terminal 41-1 generates a link local address (Link Local Address; LLA), and transmits a Neighbor Solicitation (NS) to confirm that address duplication is not included (DuplicateDADdress Detection; DAD) in such an LLA. When receiving the NS for the DAD of the LLA, the MAG discards the received NS. Next, the mobile terminal 41-1 transmits a Router Solicitation (RS) to obtain IP configuration information. When receiving the RS, the MAG 131 knows from an identifier of the mobile terminal (Mobile Node Identifier; MN-ID), which is included in the RS, that the LMA managing the movement of the mobile terminal 41-1 is the LMA 121. For example, it may be considered that the MN-ID is a MAC address of the mobile terminal. After that, by exchanging, with the LMA 121, messages of a Location Registration (LR) and a Location Registration (LR) Ack, the MAG 131 executes location registration of the mobile terminal 41-1. Here, when transmitting the LRAck to the MAG 131, the LMA 121 assigns a prefix (NetLMM Network Prefix; NNP) for the mobile terminal 41-1, and transmits the LRAck including the NNP, to the MAG 131. Next, the MAG 131 transmits a router advertisement (Router Advertisement; RA) including the NNP to a link local unicast of the mobile terminal 41-1.

After that, the mobile terminal 41-1 moves to a process for obtaining the IP address by DHCP. In such a case, the MAG 131 registers the IP address obtained by the mobile terminal 41-1 to the LMA 121 by exchanging, with the LMA 121, an MN Address Setup and an MN Address Setup Ack as linking to the message communicated between the mobile terminal 41-1 and the DHCP server 150.

Next, the mobile terminal 41-1 communicates with the packet capsuled between the LMA 121 and the MAG 131.

Here, such a technique has been proposed, that can reduce loss of a multicast packet, which is induced when a mobile node moves between sub-networks, and can improve data transmission quality by configuring a packet relaying apparatus so as to include participating requesting means for transmitting a participating request to a multicast group when receiving a participating instruction to the multicast group, which is to be transmitted until the mobile node moves at least between the sub-networks, and packet transferring means for transferring, for a predetermined term to a care-of address, the multicast packet corresponding to the multicast group, which is received after receiving location registration information including the care-of address in the sub-network to which the mobile node moves, which is transmitted when the mobile node moves between the sub-networks (for example, refer to Patent Document 1).

Such a technique has been also proposed, that enables multicast communication in a local link to be also executed between a home link and an external sub-network since a mobile router informs a home agent of the own care-of address to enable a packet of the local link, which is generated by a terminal apparatus, to be tunnel-transferred, thereby, even when the terminal apparatus moves on a foreign link, such a terminal apparatus can communicate with the terminal apparatus or a home agent on a home link in a similar way on the home link, and a tunnel packet obtained by providing a local multicast packet with a tunnel header of a global multicast address destination corresponding to an destination of the local multicast packet is transferred (for example, refer to Patent Document 2).

### Patent Document 1: Japanese Patent Laid Open Publication No. 2004-304644

### Patent Document 1: Japanese Patent Laid Open Publication No. 2005-136466

Non-Patent Document 1: Giaretta, G., “NetLMM Protocol”, HTTP://WWW.ietf.org/internet-dRAfts/dRAft-giaretta-netlmm-dt-protocol-00.txt

### DISCLOSURE OF THE INVENTION

### Problems to be Solved by the Invention

However, the above-related techniques include the following problems. The first problem is that it is necessary for the MAG to transmit a router advertisement for each mobile terminal.

That is because, when the mobile terminals belonging to the different operators are mixed under the MAG 131 as illustrated in FIG. 1, and when the router advertisement specified to each operator is transmitted by broadcast, IP configuration information on the mobile terminal, which is not related to such an operator, is rewritten.

The second problem is that, if the router advertisement is not solicited from the terminal, an access router cannot transmit the router advertisement.

That is because the MAG cannot know whether or not the target terminal is included under the own control. While the MAG can confirm the existence of the terminal as linking to a link layer, the process becomes complex.

The present invention has been made to solve the above problems, and an exemplary object of the present invention is to transmit a router advertisement collected for each feature of a terminal. Other exemplary object of the present invention is to provide an access router, a DHCP server, a router advertisement transmitting system, a method for such a system, an anchor router and a program in which a router advertisement corresponding to a feature of a terminal can be transmitted without requesting from the terminal.

### Means for Solving the Problems

The present invention includes the following characteristics to achieve the above exemplary objects.

An access router according to an exemplary aspect of the present invention includes router advertising means for transmitting a router advertisement which can be received only by a specific terminal group.

A DHCP server according to an exemplary aspect of the present invention includes means for assigning an IP address with the same solicited-node multicast address to a terminal with the same characteristics.

A router advertisement transmitting system according to an exemplary aspect of the present invention includes an access router including router advertising means for transmitting a router advertisement which can be received only by a specific terminal group, and an anchor router including means for notifying the access router of a group identifier of a group to which a terminal executing location registration belongs, at an acknowledgement of location registration.

A router advertisement transmitting method according to an exemplary aspect of the present invention includes transmitting by an access router a router advertisement which can be received only by a specific terminal group, and notifying, by an anchor router, the access router of a group identifier of a group to which a terminal executing location registration belongs, at an acknowledgement of location registration.

An anchor router according to an exemplary aspect of the present invention includes group identifier notifying means for notifying an access router of a group identifier of a group to which the terminal executing location registration belongs, at an acknowledgement of location registration.

A program according to an exemplary aspect of the present invention causes an access router to execute a process for transmitting a router advertisement which can be received only by a specific terminal group.

### ADVANTAGES OF THE INVENTION

According to the present invention, in such a condition that a variety of the terminals are mixed, the router advertisement which can be received only by the terminal with the same characteristics can be transmitted.

### BEST MODE FOR CARRYING OUT THE INVENTION

A first exemplary embodiment of the present invention will be described below in detail by referring to the drawings. As referring to FIG. 3, a router advertisement transmitting system of an exemplary embodiment includes a network 1 including router functions 61, 62, and 63, access point (Access Point; AP) functions 71, 72, and 73, and a Layer2 Switching (L2 SW) function 80, operators 11, 12, and 13, mobile terminals 41-1, 41-2, 42, and 43, and DHCP server functions 51, 52, and 53.

The operators 11, 12, and 13 are service providers providing an IP service such as HTTP to a contracted mobile terminal, and include different subnets.

The router function is an access router function for delivering an IP packet to the mobile terminal existing in the network 1, and when receiving the IP packet for the mobile terminal, the router function transfers the IP packet to an interface for the network 1 in which the mobile terminal exists. The router function also includes means for transmitting a router advertisement to a solicited-node multicast address. The router functions 61, 62, and 63 correspond to the operators 11, 12, and 13, respectively. The router function also includes a function as DHCP Relay Agent.

The AP function is an access point which is compliant with a method of IEEE 802.11. Further, the AP functions 71, 72, and 73 are independent from the operators 11, 12, and 13.

The L2 SW function 80 is a switching function for switching to an interface, in which an operator corresponding to a transmitting source MAC address exists, by referring to a transmitting source MAC address of a MAC frame in a upward direction, and switching to an interface, in which a mobile terminal corresponding to a destination MAC address exists, by referring to a destination MAC address of a MAC frame in a downward direction. The L2 SW function 80 also includes a function for switching by copying a packet for a multicast address in a downward direction to all of the interfaces in a side of the AP function.

The DHCP server functions 51, 52, and 53 include a function for assigning an IP address corresponding to the subnet included by the operator contracting with each mobile terminal.

The mobile terminal is a terminal which can move as communicating in the network 1. The mobile terminals 41-1 and 41-2 contract with the operator 11, the mobile terminal 42 contracts with the operator 12, and the mobile terminal 43 contracts with the operator 13.

Next, a total operation of the exemplary embodiment will be described in detail by referring to a sequence of FIG. 4. FIG. 4 illustrates a sequence diagram from an initial access to the network 1 to a communication start of the mobile terminals 41-1 in the router advertisement transmitting system of the exemplary embodiment. When entering the network 1, the mobile terminal 41-1 establishes a link with the AP function 71. After that, the mobile terminal 41-1 transmits a Router Solicitation (RS) to obtain IP configuration information. When receiving the MAC frame of the RS, and determining that the transmitting source MAC address is an address of the mobile terminals 41-1, the L2 SW function 80 transfers the received MAC frame of the RS to the router function 61. The timing when the L2 SW function 80 memorizes a switching path of a frame of the mobile terminals 41-1 may be a link to access authentication, or the like. When receiving the RS, the router function 61 transmits, as an acknowledge for the received RS, an RA to a link local unicast of the mobile terminals 41-1.

After that, the mobile terminals 41-1 moves to a process for obtaining the IP address by DHCP. In such a case, the DHCP server function 51 assigns a global IP address so that the terminal contracting with the operator 11 belongs to the same solicited-node multicast address.

After obtaining the IP address, the mobile terminals 41-1 communicates with the packet switched between the router function 61 and the AP function 71.

After a while, it becomes a cyclic transmission timing for the router advertisement. At such a timing, the router function 61 transmits the router advertisement to the solicited-node multicast for the operator 11. When confirming that the destination MAC address of the MAC frame of this router advertisement is an address for broadcast, the L2 SW function 80 copies this router advertisement to deliver the copied router advertisement to all of the APs.

Next, advantageous effect of the exemplary embodiment will be described.

In the exemplary embodiment, the IP address is assigned by a DHCP server so that the solicited-node multicast address becomes common, so that the desired router advertisement can be transmitted at once only to the specific terminal group.

In the exemplary embodiment, further, the router advertisement is transmitted to a unicast address of the terminal at the initial access to the network 1, so that the desired router advertisement can be also delivered even if the terminal is not grouped.

Next, a second exemplary embodiment of the present invention will be described in detail by referring to the drawings.

As referring to FIG. 5, the exemplary embodiment includes the network 1 configured with LMA functions 21, 22, and 23, MAG functions 31, 32, and 33, and a DHCP server function 50, the operators 11, 12, and 13, and the mobile terminals 41-1, 41-2, 42, and 43.

The operators 11, 12, and 13 are service providers providing the IP service such as the HTTP to the contracted mobile terminal, and include the different subnets.

The LMA function is an anchor router function which supports a NetLMM protocol when the mobile terminal moves in the network 1, and when receiving the IP packet for the mobile terminal, whose movement is managed, the LMA function capsules an IP packet to transfer the capsuled IP packet to the MAG function, in which the mobile terminal exists. The LMA functions 21, 22, and 23 correspond to the operators 11, 12, and 13, respectively. The LMA function includes a function for transmitting a location registration acknowledge from the MAG function, including the solicited-node multicast address utilized by the mobile terminal.

The MAG function is an access router function for supporting the NetLMM protocol executing a location registration in the LMA function instead of the mobile terminal when the mobile terminal moves under the own control. The MAG function also includes a function as a DHCP Relay Agent, and includes a function for adding group information of a group to which the mobile terminal belongs when transferring a DHCP message to the DHCP server. Further the MAG functions 31, 32, and 33 are independent from the operators 11, 12, and 13.

The DHCP server function 50 includes a function for assigning the IP address corresponding to the subnet and the group included-by the operator contracting each with mobile terminal.

The mobile terminal is a terminal which can move as communicating in the network 1. The mobile terminals 41-1 and 41-2 contract with the operator 11, the mobile terminal 42 contracts with the operator 12, and the mobile terminal 43 contracts with the operator 13.

The router advertisement transmitting system with such a configuration of the exemplary embodiment operates as follows. FIG. 6 illustrates a sequence diagram from the initial access to the network 1 to the communication start of the mobile terminals 41-1 in the router advertisement transmitting system of the exemplary embodiment.

When entering the network 1, the mobile terminal 41-1 establishes a link with the MAG function 31. After that, the network 1 generates an LLA, and transmits the NS to confirm that address duplication (DAD) is not included in the generated LLA. When receiving the NS for the DAD of the LLA, the MAG function 31 discards the received NS. Next, the mobile terminal 41-1 transmits the RS to obtain the IP configuration information. When receiving the RS, the MAG function 31 knows from a MN-ID, which is included in the RS, that the LMA function managing the movement of the mobile terminal 41-1 is the LMA function 21. For example, it may be considered that the MN-ID is a MAC address of the mobile terminal. After that, by exchanging, with the LMA function 21, messages of an LR and an LRAck, the MAG function 31 executes a location registration of the mobile terminal 41-1. Here, when transmitting the LRAck to the MAG function 31, the LMA function 21 assigns a NNP for the mobile terminal 41-1, and transmits, to the MAG function 31, the LRAck by adding the NNP and including the solicited-node multicast address which may be assigned to the mobile terminal. Next, the MAG function 31 transmits the RA including the NNP to the link local unicast of the mobile terminal 41-1.

After that, the mobile terminal 41-1 moves to a process for obtaining the IP address by DHCP. In such a case, when transferring a DHCP Request to the DHCP server function 50, the MAG function 31 adds LMA-ID, which is an identifier of the LMA function, as the group information of a group to which the mobile terminal belongs. The DHCP server function 50 assigns the global IP address so that the solicited-node multicast address corresponding to the added group information of the mobile terminal is assigned. The MAG function 31 registers the IP address obtained by the mobile terminal 41-1 to the LMA function 21 by exchanging a MN address Setup and a MN address Setup Ack with the LMA function 21 as linking to the message communicated by the mobile terminal 41-1 and the DHCP server function 50.

Next, the mobile terminal 41-1 communicates with the packet capsuled between the LMA function 21 and the MAG function 31.

After a while, it becomes a cyclic transmission timing for the router advertisement. In such a case, the MAG function 31 transmits the router advertisement to the solicited-node multicast for the operator 11.

Next, a handover operation in the router advertisement transmitting system of the exemplary embodiment will be described. FIG. 7 illustrates a sequence diagram of the handover from the MAG function 31 to the MAG function 32 of the mobile terminal 41-1 in the router advertisement transmitting system of the exemplary embodiment. When moving under the control of the MAG function 32, the mobile terminal 41-1 establishes a link with the MAG function 32. After that, the mobile terminal 41-1 transmits the RS to obtain the IP configuration information. When receiving the RS, the MAG function 32 knows from the MN-ID included in the RS in a similar way to a case of the initial access described in FIG. 6 that the LMA function for Managing the movement of the mobile terminal 41-1 is the LMA function 21. After that, the MAG function 32 transmits the LR to the LMA function 21 to execute the location registration of the mobile terminal 41-1. When receiving the LR, the LMA function 21 exchanges a Routing Setup and a Routing Setup Ack with the MAG function 32 to change path information on the mobile terminal. After that, the LMA function 21 transmits, to the MAG function 32, the LRAck by adding the NNP for the mobile terminal 41-1 and including the solicited-node multicast address corresponding to the group of the mobile terminal 41-1.

Next, the MAG function 32 transmits the RA including the NNP to the link local unicast of the mobile terminal 41-1. Here, while the MAG function 32 transmits the RA to the link local unicast address of the mobile terminal 41-1, since the mobile terminal holds the solicited-node multicast address corresponding to the group in a stage of the handover, the MAG function 32 may transmit the RA to the solicited-node multicast address.

Finally, the LMA function 21 exchanges a Location Deregistration and a Location Deregistration Ack with the MAG function 31 to delete a cache of the mobile terminal 41-1 on the MAG function 31.

After a while, it becomes a cyclic transmission timing for the router advertisement. At such a timing, the MAG function 32 transmits the router advertisement to the solicited-node multicast for the operator 11.

Next, advantageous effect of the exemplary embodiment will be described.

In the exemplary embodiment, since the solicited-node multicast address, which is the group identifier of the mobile terminal, is notified to the access router at the handover of the mobile terminal, the router advertisement for the terminal group can be continuingly transmitted even after the handover of the mobile terminal.

Next, an operation of the first exemplary embodiment of the present invention will be described by using a specific exemplary embodiment.

As referring to FIG. 8, the exemplary embodiment includes the network 1 configured with routers 161, 162, and 163, Aps 171, 172, and 173, and a Broadband Access Service 180, the operators 11, 12, and 13, the mobile terminals 41-1, 41-2, 42, and 43, and DHCP servers 151, 152, and 153.

The operators 11, 12, and 13 are service providers providing the IP service such as the HTTP to the contracted mobile terminal, and include the different subnets.

The router is an access router for delivering the IP packet to the mobile terminal existing in the network 1, and when receiving the IP packet for the mobile terminal, the router transfers the IP packet to the interface for the network 1 in which the mobile terminal exists. The router also includes means for transmitting the router advertisement to the solicited-node multicast address. The routers 161, 162, and 163 correspond to the operators 11, 12, and 13, respectively. The router also includes a function as the DHCP Relay Agent.

The AP is the access point which is compliant with the method of IEEE 802.11. Further, the APs 171, 172, and 173 are independent of the operators 11, 12, and 13.

A BAS 180 is a switching apparatus for switching to the interface, in which the operator corresponding to the transmitting source MAC address exists, by referring to the transmitting source MAC address of the MAC frame in a upward direction, and switching to the interface, in which the mobile terminal corresponding to the destination MAC address exists, by referring to the destination MAC address of the MAC frame in a downward direction. The BAS 80 also includes a function for switching by copying the packet for the multicast address in a downward direction to all of the interfaces in a side of the AP.

The DHCP servers 151, 152, and 153 include a function for assigning the IP address corresponding to the subnet included by the operator contracting with the mobile terminal.

The mobile terminal is a terminal which can move as communicating in the network 1. The mobile terminals 41-1 and 41-2 contract with the operator 11, the mobile terminal 42 contracts with the operator 12, and the mobile terminal 43 contracts with the operator 13.

Next, a total operation of the exemplary embodiment will be described in detail by referring to a sequence of FIG. 9. FIG. 9 illustrates a sequence diagram from the initial access to the network 1 to the communication start of the mobile terminals 41-1 in the router advertisement transmitting system of the exemplary embodiment. When entering the network 1, the mobile terminal 41-1 establishes a link with the AP 171. After that, the mobile terminal 41-1 transmits the RS to obtain IP configuration information. When receiving the MAC frame of the RS, and determining that the transmitting source MAC address is an address of the mobile terminals 41-1, the BAS 180 transfers the received MAC frame of the RS to the router 161. The timing when the BAS 180 memorizes the switching path of the frame of the mobile terminals 41-1 is a link to the access authentication, or the like. When receiving the RS, the router 161 transmits, as the acknowledge for the received RS, the RA to the link local unicast of the mobile terminals 41-1.

After that, the mobile terminals 41-1 moves to a process for obtaining the IP address by the DHCP. In such a case, the DHCP server 151 assigns the global IP address so that the terminal contracted with the operator 11 belongs to the same solicited-node multicast address.

After obtaining the IP address, the mobile terminals 41-1 communicates with the packet switched between the router function 161 and the AP 171.

After a while, it becomes a cyclic transmission timing for the router advertisement. At such a timing, the router 161 transmits the router advertisement to the solicited-node multicast for the operator 11. When confirming that the destination MAC address of the MAC frame of this router advertisement is an address for broadcast, the BAS 180 copies this router advertisement to deliver the copied router advertisement to all of the APs.

Next, an operation of the second exemplary embodiment of the present invention will be described by using a specific exemplary embodiment.

As referring to FIG. 10, the exemplary embodiment includes the network 1 configured with LMAs 121, 122, and 123, MAGs 131, 132, and 133, and a DHCP server 150, the operators 11, 12, and 13, and the mobile terminals 41-1, 41-2, 42, and 43.

The operators 11, 12, and 13 are service providers providing the IP service such as the HTTP to the. contracted mobile terminal, and include the different subnets.

The LMA is an anchor router which supports the NetLMM protocol when the mobile terminal moves in the network 1, and when receiving the IP packet for the mobile terminal, whose movement is managed, the LMA capsules the IP packet to transfer the capsuled IP packet to the MAG, in which the mobile terminal exists. The LMAs 121, 122, and 123 correspond to the operators 11, 12, and 13, respectively. The LMA includes a function for transmitting the location registration acknowledge from the MAG including the solicited-node multicast address utilized by the mobile terminal.

The MAG is an access router for supporting the NetLMM protocol executing a location registration in the LMA instead of the mobile terminal when the mobile terminal moves under the own control. The MAG also includes a function as the DHCP Relay Agent, and includes a function for adding the group information to which the mobile terminal belongs when transferring the DHCP message to the DHCP server. Further the MAGs 131, 132, and 133 are independent of the operators 11, 12, and 13.

The DHCP server 150 .includes a function for assigning the IP address corresponding to the subnet and the group included by the operator contracting with each mobile terminal.

The mobile terminal is a terminal which can move as communicating in the network 1. The mobile terminals 41-1 and 41-2 contract with the operator 11, the mobile terminal 42 contracts with the operator 12, and the mobile terminal 43 contracts with the operator 13.

The router advertisement transmitting system with such a configuration of the exemplary embodiment operates as follows. FIG. 11 illustrates a sequence diagram from the initial access to the network 1 to the communication start of the mobile terminals 41-1 in the router advertisement transmitting system of the exemplary embodiment.

When entering the network 1, the mobile terminal 41-1 establishes a link with the MAG 131. After that, the mobile terminal 41-1 generates an LLA, and transmits the NS to confirm that the address duplication (DAD) is not included in the generated LLA. When receiving the NS for the DAD of the LLA, the MAG 131 discards the received NS.

Next, the mobile terminal 41-1 transmits the RS to obtain the IP configuration information. When receiving the RS, the MAG 131 knows from the MN-ID, which is included in the RS, that the LMA managing the movement of the mobile terminal 41-1 is the LMA 121. For example, it may be considered that the MN-ID is the MAC address of the mobile terminal. After that, by exchanging, with the LMA 121, messages of the LR and the LRAck, the MAG 131 executes the location registration of the mobile terminal 41-1. Here, when transmitting the LRAck to the MAG 131, the LMA 121 assigns the NNP for the mobile terminal 41-1, and transmits, to the MAG 131, the LRAck by adding the NNP and including the solicited-node multicast address which may be assigned to the mobile terminal. Next, the MAG 131 transmits the RA including the NNP to the link local unicast of the mobile terminal 41-1.

After that, the mobile terminal 41-1 moves to a process for obtaining the IP address by the DHCP. In such a case, when transferring the DHCP Request to the DHCP server 150, the MAG 131 adds the LMA-ID, which is an identifier of the LMA function, as the group information, to which the mobile terminal belongs. The DHCP server 150 assigns the global IP address so that the solicited-node multicast address corresponding to the added group information of the mobile terminal is assigned. The MAG 131 registers the IP address obtained by the mobile terminal 41-1 to the LMA 121 by exchanging the MN address Setup and the MN address Setup Ack with the LMA 121 as linking to the message communicated by the mobile terminal 41-1 and the DHCP server 150.

Next, the mobile terminal 41-1 communicates with the packet capsuled between the LMA 121 and the MAG 131.

After a while, it becomes a cyclic transmission timing for the router advertisement. In such a case, the MAG 131 transmits the router advertisement to the solicited-node multicast for the operator 11.

Next, the handover operation in the router advertisement transmitting system of the exemplary embodiment will be described. FIG. 12 illustrates a sequence diagram of the handover from the MAG 131 to the MAG 132 of the mobile terminal 41-1 in the router advertisement transmitting system of the exemplary embodiment. When moving under the control of the MAG 132, the mobile terminal 41-1 establishes a link with the MAG 132. After that, the mobile terminal 41-1 transmits the RS to obtain the IP configuration information.

When receiving the RS, the MAG 132 knows from the MN-ID included in the RS in a similar way to a case of the initial access described in FIG. 11 that the LMA for managing the movement of the mobile terminal 41-1 is the LMA 121. After that, the MAG 132 transmits the LR to the LMA 121 to execute the location registration of the mobile terminal 41-1. When receiving the LR, the LMA 121 exchanges the Routing Setup and the Routing Setup Ack with the MAG 132 to change the path information on the mobile terminal. After that, the LMA 121 transmits, to the MAG 132, the LRAck by adding the NNP for the mobile terminal 41-1 and including the solicited-node multicast address corresponding to the group of the mobile terminal 41-1. Next, the MAG 132 transmits the RA including the NNP to the link local unicast of the mobile terminal 41-1.

Here, while the MAG 132 transmits the RA to the link local unicast of the mobile terminal 41-1, since the mobile terminal holds the solicited-node multicast address corresponding to the group in a stage of the handover, the MAG 132 may transmit the RA to the solicited-node multicast address. Finally, the LMA 121 exchanges the Location Deregistration and the Location Deregistration Ack with the MAG function 31 to delete the cache of the mobile terminal 41-1 on the MAG 131.

After a while, it becomes a cyclic transmission timing for the router advertisement. At such a timing, the MAG 132 transmits the router advertisement to the solicited-node multicast for the operator 11.

In the present specifications described above, the solicited-node multicast address is exemplified as the identifier for determining the group to which the router advertisement is transmitted, however, the solicited-node multicast address is not used, but an option field dedicated for identifying the group may be embedded in the router advertisement, or may be embedded in a MAC frame header. In such a case, the terminal needs a function for determining such a group identifier.

Meanwhile, each of the above exemplary embodiments is the preferred exemplary embodiment of the present invention, and a variety of changes can be applied without departing from the scope of the concept of the present invention. For example, such a process may be executed, in that each apparatus configuring the router advertisement transmitting system is caused to read a program for realizing a function of such an apparatus, and to execute the read program, thereby, the function of each apparatus is realized. Further, the program may be transferred to another computer system through a CD-ROM or a magnetic-optical disk, or the like which is a computer-readable recording medium, or by a transmitted wave through the Internet, a phone line, or the like which is a transmission medium.

The present invention can be applied to an application such as an access system which is communally used by a plurality of ISPs such as a WLAN provider. Further, the present invention can be also applied to an application such as a NetLMM system which is communally used by a plurality of the ISPs.

This application is based upon and claims the benefit of priority from Japanese patent application No. 2006-252795, filed on Sep. 19, 2006, the disclosure of which is incorporated herein in its entirety by reference.

### INDUSTRIAL APPLICABILITY

The access router, the DHCP server, the router advertisement transmitting system, the method for such a system, the anchor router and the program according to the present invention are preferable to transmit the router advertisement, which can be received only by the terminal with the same characteristics, in a condition that a variety of the terminals are mixed.

### BRIEF DESCRIPTION OF THE DRAWINGS

FIG. 1 is a system diagram illustrating a configuration of a related technique;

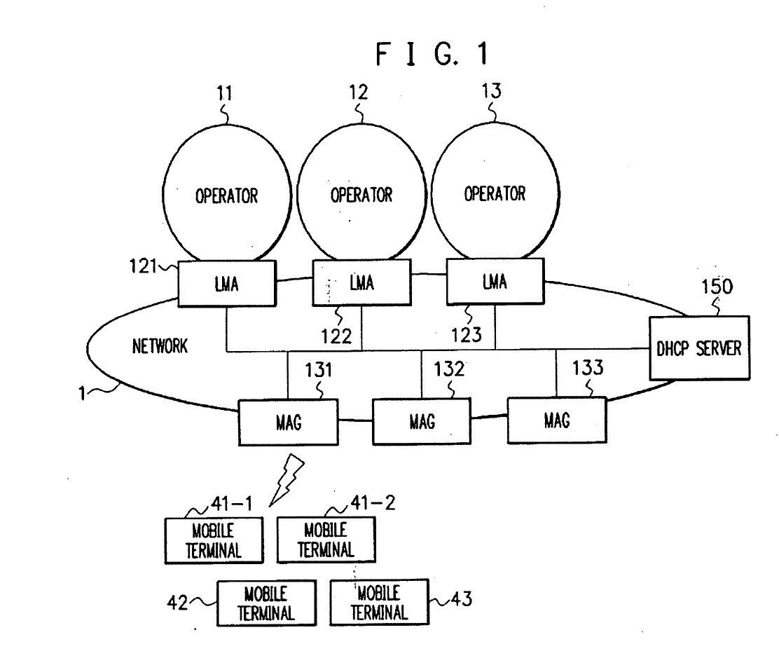

FIG. 2 is a sequence diagram from an initial access to a communication start, which illustrates operations of the related technique;

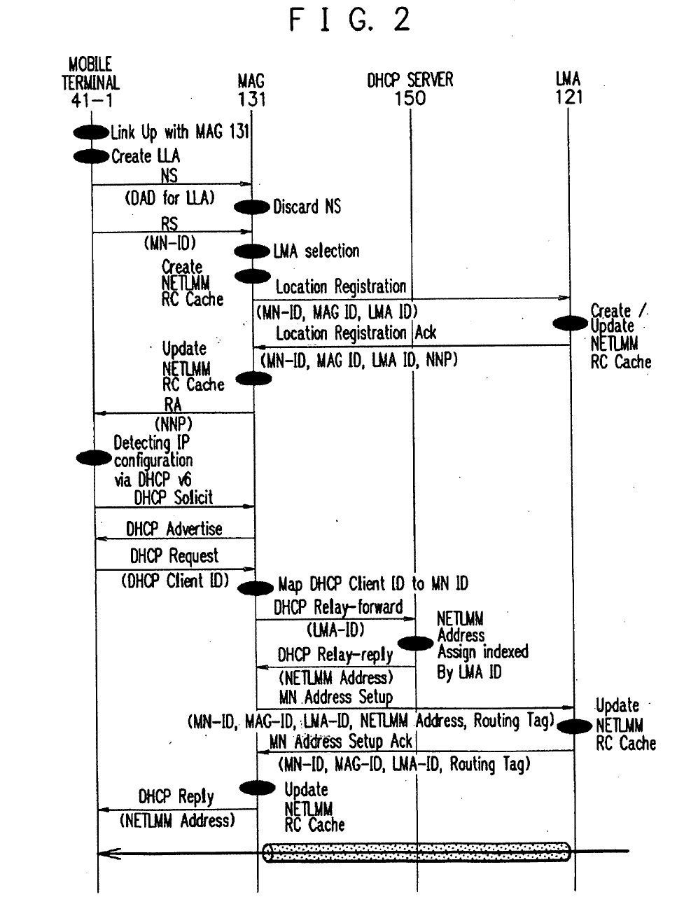

FIG. 3 is a system diagram illustrating a configuration of a first exemplary embodiment of the present invention;

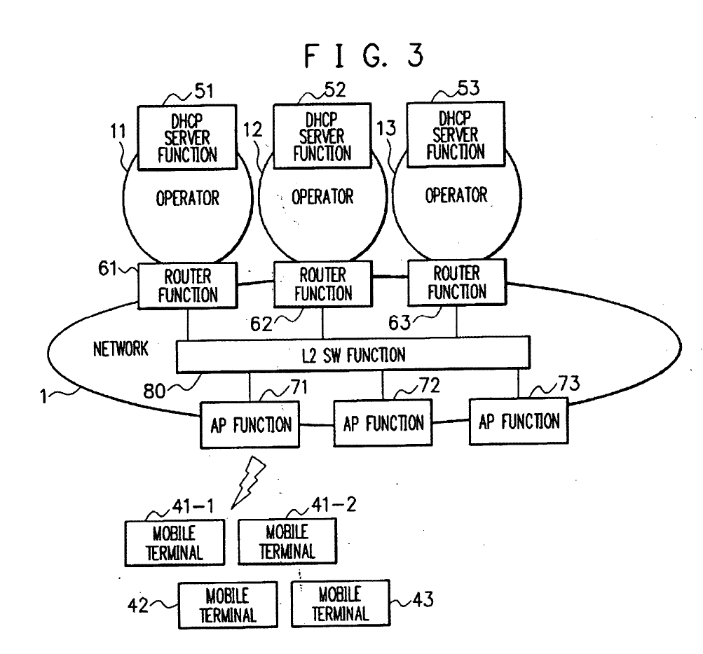

FIG. 4 is a sequence diagram from the initial access to the communication start, which illustrates operations of the first exemplary embodiment;

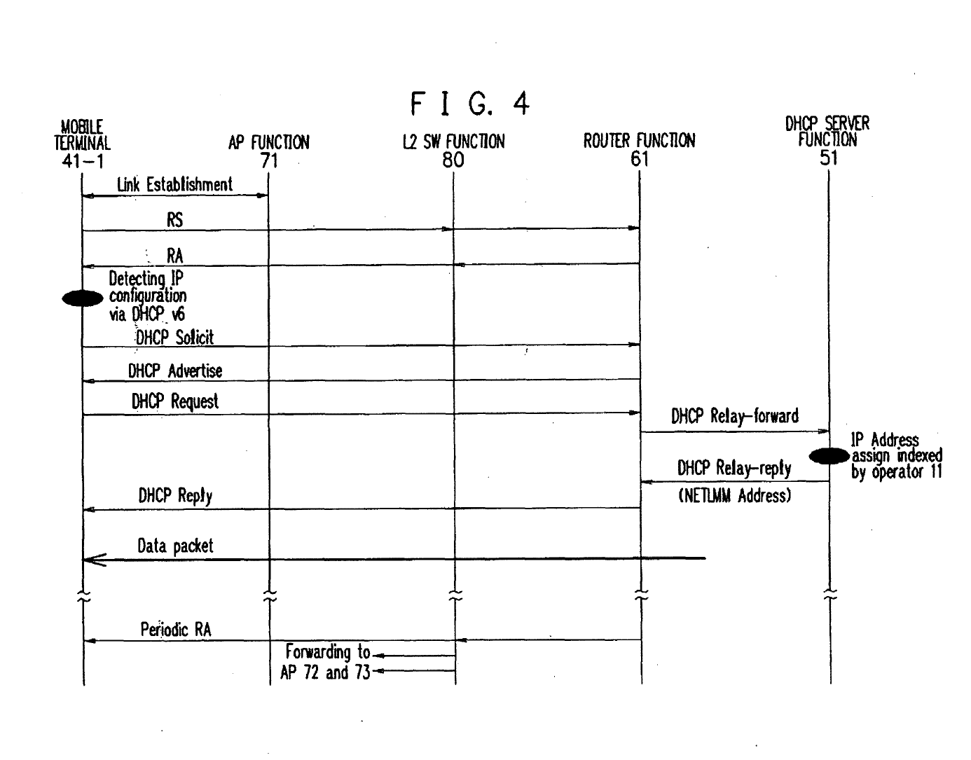

FIG. 5 is a system diagram illustrating a configuration of a second exemplary embodiment of the present invention;

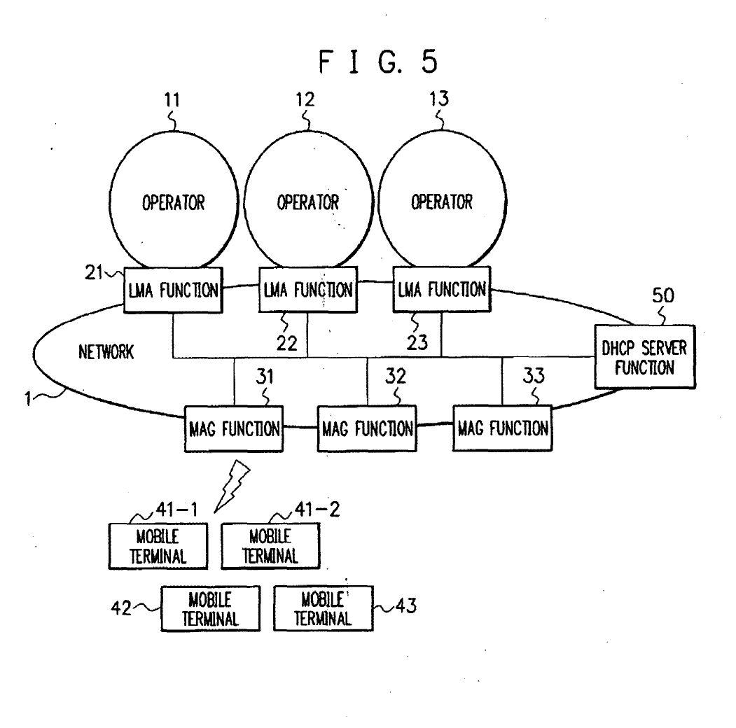

FIG. 6 is a sequence diagram from the initial access to the communication start, which illustrates operations of the second exemplary embodiment;

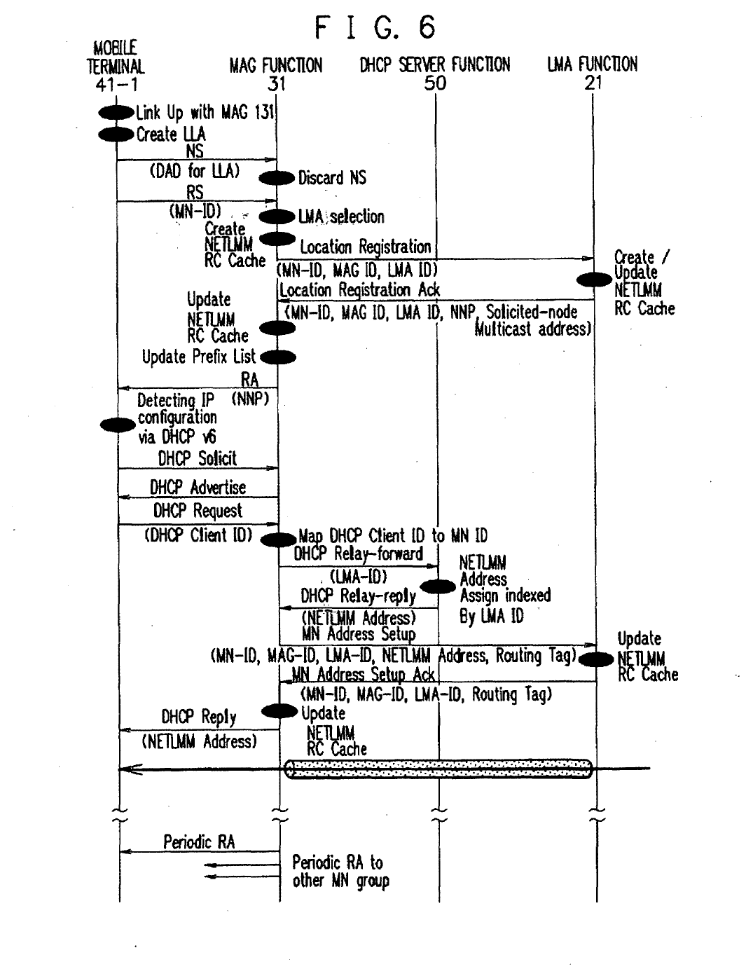

FIG. 7 is a handover sequence diagram illustrating the operations of the second exemplary embodiment;

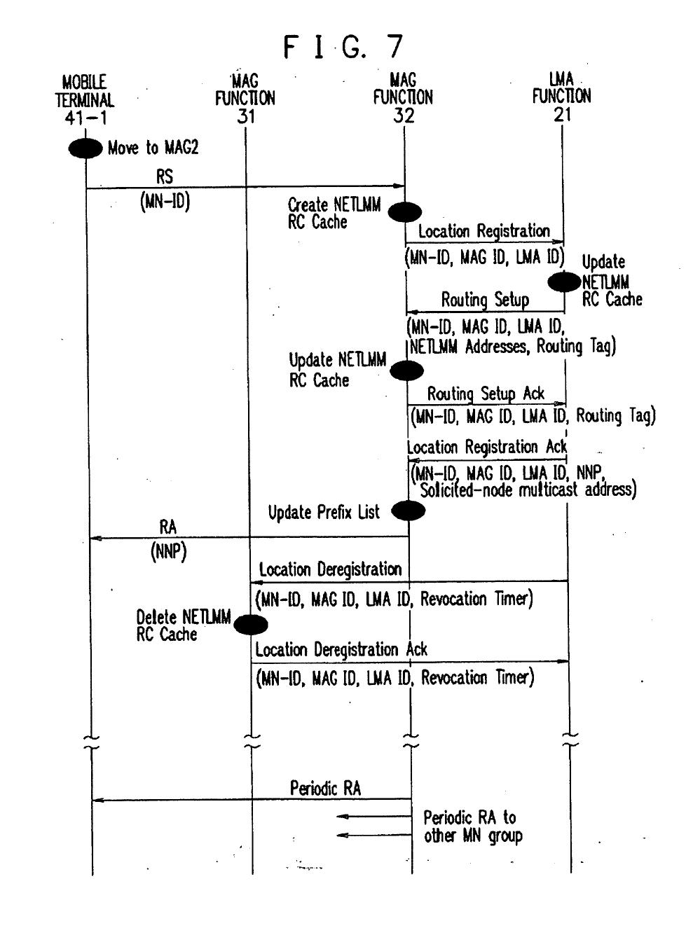

FIG. 8 is a system diagram illustrating a configuration of an exemplary embodiment of the first exemplary embodiment;

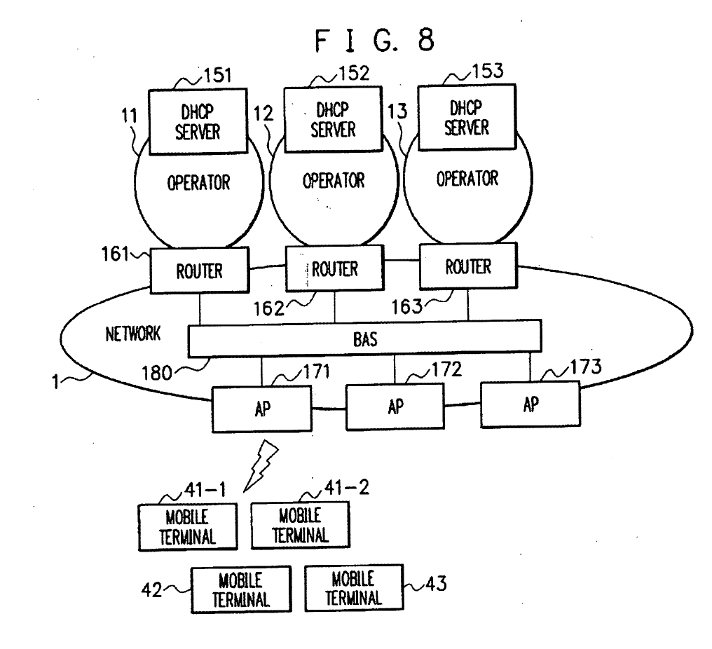

FIG. 9 is a sequence diagram from the initial access to the communication start, which illustrates the operations of the exemplary embodiment of the first exemplary embodiment;

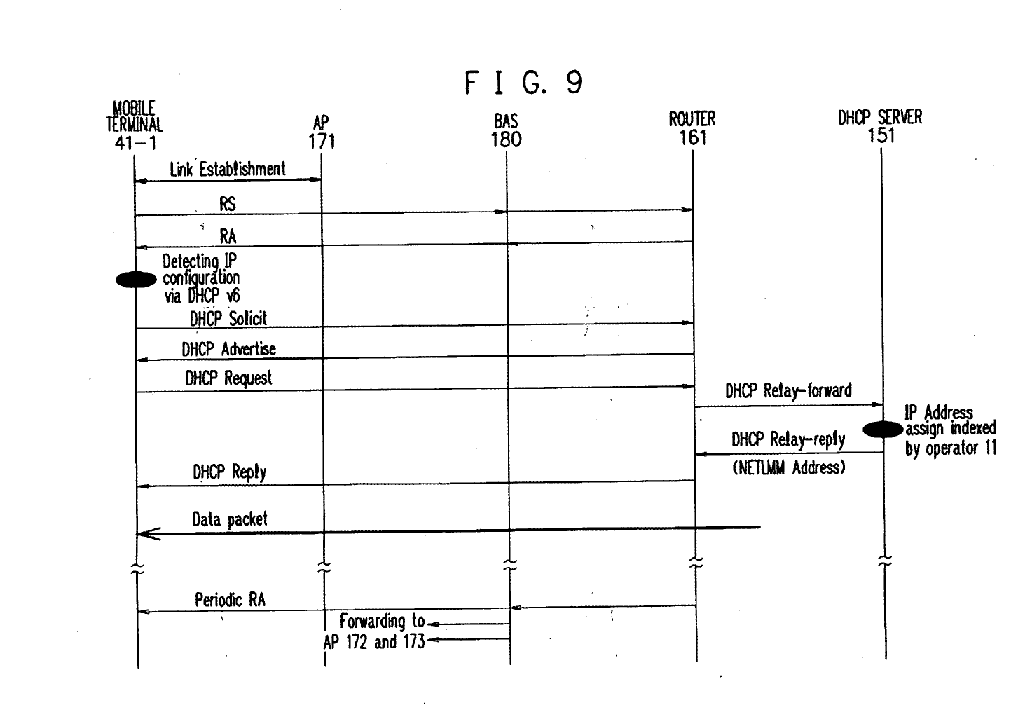

FIG. 10 is a system diagram illustrating a configuration of the exemplary embodiment of the second exemplary embodiment;

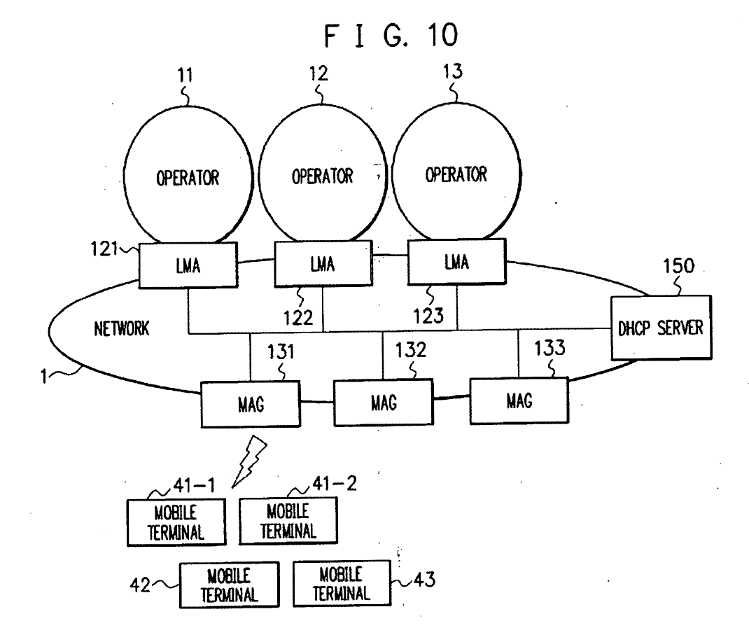

FIG. 11 is a sequence diagram from the initial access to the communication start, which illustrates the operations of the exemplary embodiment of the second exemplary embodiment; and

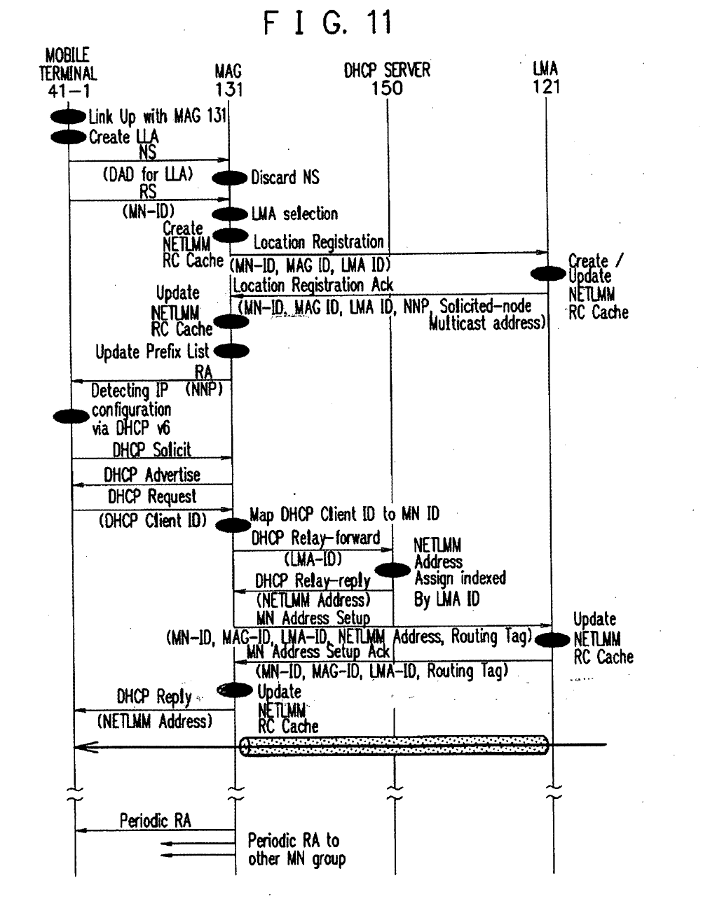

FIG. 12 is a handover sequence diagram illustrating the operations of the exemplary embodiment of the second exemplary embodiment.

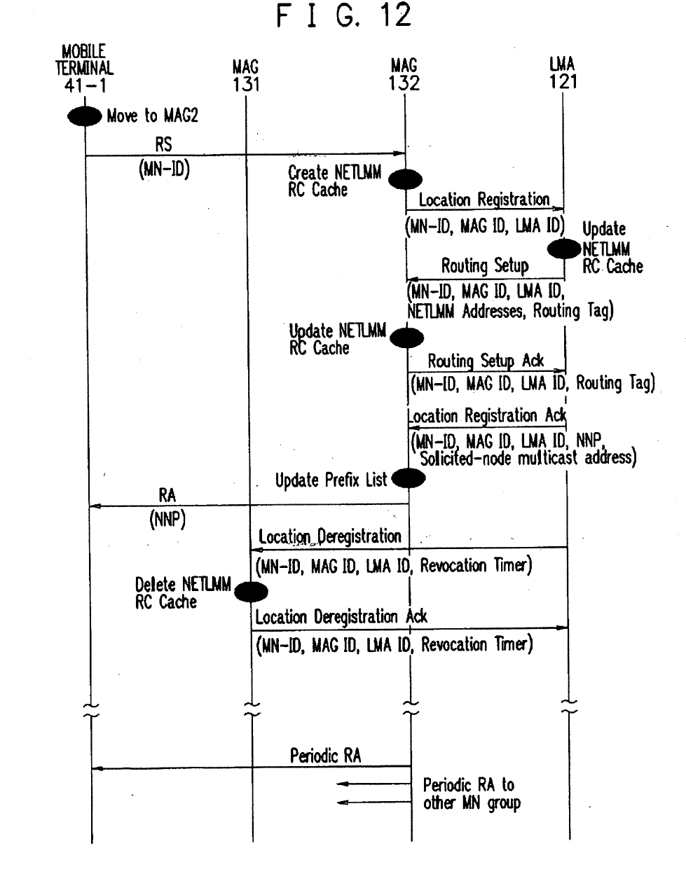

### DESCRIPTION OF SYMBOLS

1 network
11, 12, 13 operator
21, 22, 23 Local Mobility Anchor (LMA) function
31, 32, 33 Mobility Access Gateway (MAG) function
41-1, 41-2, 42, 43 mobile terminal
50, 51, 52, 53 DHCP server function
61, 62, 63 router function
71, 72, 73 Access Point (AP) function
80 Layers2 Switching (L2 SW) function
121, 122, 123 Local Mobility Anchor (LMA)
131, 132, 133 Mobility Access Gateway (MAG)
150, 151, 152, 153 DHCP server
161, 162, 163 router
171, 172, 173 Access Point (AP)
180 Broadband Access Server (BAS)

1. An access router comprising:
a router advertising unit which transmits a router advertisement which can be received by a specific terminal group.

2. The access router according to claim 1, wherein
the router advertising unit causes a member belonging to the specific terminal group to receive the router advertisement by using a solicited-node multicast address as a destination address of the router advertisement.

3. The access router according to claim 2, wherein
the router advertising unit uses a unicast address as the destination address of the router advertisement in a case of an initial access to a network of a terminal.

4. The access router according to claim 1, further comprising an address list, a multicast address to be transmitted to the terminal being described in the address list.

5. A DHCP server comprising:
a unit which assigns an IP address with the same solicited-node multicast address to a terminal with the same characteristics.

6. A router advertisement transmitting system comprising:
an access router including a router advertising unit which transmits a router advertisement which can be received by a specific terminal group; and
an anchor router including a group identifier notifying unit which notifies the access router of a group identifier of a group to which a terminal executing location registration belongs, at an acknowledgement of location registration.

7. A router advertisement transmitting method comprising:
transmitting by an access router a router advertisement which can be received by a specific terminal group; and
notifying, by an anchor router, the access router of a group identifier of a group to which a terminal executing location registration belongs, at an acknowledgement of location registration.

8. An anchor router comprising:
a group identifier notifying unit which notifies an access router of a group identifier of a group to which a terminal executing location registration belongs, at an acknowledgement of location registration.

9. The anchor router according to claim 8, wherein
the group identifier notifying unit uses a solicited-node multicast address as the group identifier.

10. A storage medium for storing a program causing an access router to execute a process for transmitting a router advertisement which can be received by a specific terminal group.

11. A storage medium for storing a program causing a DHCP server to execute a process for assigning an IP address with the same solicited-node multicast address to a terminal with the same characteristics.

12. A storage medium for storing a program causing an anchor router to execute a process for notifying an access router of a group identifier of a group to which a terminal executing location registration belongs, at an acknowledgement of location registration.

13. The storage medium for storing the program according to claim 12, wherein
in the process for notifying, a solicited-node multicast address is used as the group identifier.

14. An access router comprising:
router advertising means for transmitting a router advertisement which can be received by a specific terminal group.

15. A DHCP server comprising:
means for assigning an IP address with the same solicited-node multicast address to a terminal with the same characteristics.

16. A router advertisement transmitting system comprising:
an access router including router advertising means for transmitting a router advertisement which can be received by a specific terminal group; and
an anchor router including means for notifying the access router of a group identifier of a group to which a terminal executing location registration belongs, at an acknowledgement of location registration.

17. An anchor router comprising:
group identifier notifying means for notifying an access router of a group identifier of a group to which a terminal executing location registration belongs, at an acknowledgement of location registration.
